(19) United States
(12) Patent Application Publication
(10) Pub. No.: US 2026/0360580 A1
(43) Pub. Date: Nov. 12, 2026

(54) NEUTRON REFLECTOR WITH IRRADIATION SPECIMEN HOUSING FOR ISOTOPE PRODUCTION

(71) Applicant: NuScale Power, LLC, Corvallis, OR (US)

(72) Inventors: Aaron Pierce, Albany, OR (US); Kevin Heimbach, Chambersburg, PA (US)

(21) Appl. No.: 19/669,377

(22) Filed: May 6, 2026

Related U.S. Application Data
(60) Provisional application No. 63/801,896, filed on May 8, 2025.

(51) Int. Cl. G21C 19/20; G21C 11/06; G21G 1/02

(52) U.S. Cl. CPC G21C 19/20; G21C 11/06; G21G 1/02

(57) ABSTRACT

A system comprising a nuclear power plant, including a reactor core, and a reactor core support assembly adjacent to the reactor core, the reactor core support including a neutron reflector, a specimen capsule well extending from a top end of the neutron reflector toward the bottom end of the neutron reflector, an isotope specimen capsule disposed within the specimen capsule well, and an isotope specimen disposed within the isotope specimen capsule.

### CROSS-REFERENCED TO RELATED APPLICATIONS

This application claims priority to U.S. Provisional Patent Application No. 63/801,896, filed May 8, 2025, and titled “NEUTRON REFLECTOR WITH IRRADIATION SPECIMEN HOUSING FOR ISOTOPE PRODUCTION,” which is incorporated herein by reference in its entirety.

### BACKGROUND

There is a high demand for nuclear isotopes around the world, and the demand is growing. Radioisotopes are used in a wide variety of applications across many industries, including medicine, food, agriculture, and research. One way to produce these radioisotopes is within a nuclear fission reactor. Typically, pressurized light-water reactors must cycle through startup and shut down cycles frequently to load materials into the reactor pressure vessel in order to produce nuclear isotopes and collect the nuclear isotopes when they are satisfactorily irradiated.

Typically, the nuclear reactors used for generating and providing thermal and electrical energy for industrial and domestic power systems must remain online and operational for extended periods of time in order to provide a steady power supply. In a typical pressurized light-water reactor, shutting down the reactor to insert or remove isotopes reduces the electricity or steam output to zero. However, a configuration comprised of several small modular reactors can still produce electricity or steam if some reactors need to shut down to install or retrieve isotopes as long as at least one (1) reactor remains operational. Accordingly, collocating small modular reactors at a single facility is advantageous for producing nuclear isotopes compared to a typical nuclear power plant.

### BRIEF DESCRIPTION OF THE DRAWINGS

FIG. 1 schematically illustrates a Small Modular Reactor (SMR) system integrated with Nuclear Power Modules (NPMs) that include an embodiment of a core support assembly, according to an embodiment of this disclosure.

FIG. 2 illustrates an isometric view of a core support assembly, according to an embodiment of this disclosure.

FIG. 3 illustrates a close-up isometric view of the top of a core support assembly, according to an embodiment of this disclosure.

FIG. 4 illustrates a cross-sectional view of a core support assembly, according to an embodiment of this disclosure.

FIG. 5 illustrates a top-down view of a lower reactor pressure vessel with specimen capsule extraction holes, according to an embodiment of this disclosure.

FIG. 6 illustrates a cross-sectional view of a partially disassembled lower portion of the reactor pressure vessel, according to an embodiment of this disclosure.

FIG. 7 illustrates a partially exploded view of a core support assembly, according to an embodiment of this disclosure.

FIG. 8 is a partially schematic, partially cross-sectional view of a nuclear reactor system configured in accordance with an embodiment of the present technology.

FIG. 9 is a partial schematic, partial cross-sectional view of a nuclear reactor system configured in accordance with an embodiment of the present technology.

FIG. 10 is a schematic view of a nuclear power plant system including multiple nuclear reactors, according to an embodiment of this disclosure.

### DETAILED DESCRIPTION

### Overview

This Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

This disclosure is directed generally to address the problem of producing radioisotopes for medical and industrial applications. Gamma irradiation has a wide range of uses in the medical, food, agricultural and research fields. Some of the applications include sterilizing medical equipment, cancer treatment, extending the shelf-life of food products, reducing the spread of disease-carrying or crop damaging pests, and testing and radiation certification of satellite and weapons system electronic components, among many others.

Cobalt-60 (Co-60) may be one of the isotopes used for the applications listed above, in addition to many other applications as well. Co-60 is an unstable isotope (i.e., it will radioactively decay over time) that has a half-life of approximately 5.2 years. Typically, Co-60 is produced by installing naturally occurring Co-59 (a stable isotope that does not radioactively decay), into a nuclear reactor and exposing the Co-59 to neutrons while the nuclear reactor operates. After a period of time, the stable Co-59 is converted into Co-60 as a result of its exposure to the gamma radiation produced by the nuclear reactor. Once the Co-60 has been produced, the Co-60 may be collected, and a new portion of Co-59 may be installed for processing.

In an embodiment, other isotopes may be produced by irradiating their stable precursors in a similar manner. For example, Nickel-63 may be produced by installing naturally occurring Nickel-62 into a nuclear reactor and exposing the Nickel-62 to neutrons while the nuclear reactor operates. Similarly, Actinium-227 may be produced by irradiating Radium-226, Iron-55 may be produced by irradiating Iron-54, and Thallium-204 may be produced by irradiating Thallium-203. After a period of time, the stable isotope is converted into the desired radioisotope as a result of its exposure to neutrons produced by the nuclear reactor. Once the radioisotope has been produced, the radioisotope may be collected, and a new portion of the stable precursor isotope may be installed for processing.

Cesium-137 (which has a 30.17 year half-life), Strontieum-90 (which has a 28.79 year half-life), Promethium-147 (which has a 2.62 year half-life), Americium-241 (which has a 432.2 year half-life), Californium-252 (which has a 2.64 year half-life), Actinium-227 (which has a 21.8 year Half-life), Aluminum-26 (which has a 717,000 year half-life), Barium-133 (which has a 10.551 year half-life), Bismuth-207 (which has a 31.55 year half-life), Iron-55 (which has a 2.74 year half-life), Titanium-44 (which has a 59.1 year half-life), Nickel-63 (which has a 100.1 year half-life), and Thallium-204 (which has a 3.78 year half-life) may also be produced in addition to, or instead of, Co-60.

Small modular reactors (SMRs) are designed to provide continuous thermal and electrical energy and undergo refueling every 18 to 24 months, approximately. In an embodiment, a power plant system may include multiple SMRs which may allow one or more SMRs to operate while one or more other SMRs are undergoing the refueling process.

In an embodiment, fuel usage may be optimized in a multiple-module configuration such that one or more reactors may operate for shorter cycle durations to facilitate harvesting radioisotopes with half-lives that are less than typical 18 to 24 month refueling cycles. In some aspects, partially burned fuel assemblies from one module may be transferred to another module, providing additional flexibility in fuel management and isotope production scheduling.

In an embodiment, during the refueling process, the lower riser assembly of a Nuclear Power Module (NPM) may be lifted off of the core support assembly and moved to a different location for refueling. When the lower riser assembly is removed from the core support assembly, the upper core plate (which is attached to the lower riser assembly) is also removed. In an embodiment, the upper core plate may include extraction holes that are sized to allow for access to one or more specimen capsules within the core support assembly without removing the entire lower riser assembly. In an embodiment the specimen capsules may be removed from and re-installed into the core support assembly while the lower riser assembly is undergoing the refueling process.

In an embodiment, a core support assembly may include two (2) components: a neutron reflector and a specimen capsule housing with an integral specimen cap. The specimen cap may be configured to engage with a lifting feature (e.g., an integral lifting lug/shackle for a crane, etc.). A stable isotope of a material may be loaded into the specimen capsule housing, which is sealed by the specimen cap. In an embodiment, the specimen capsule may be installed into the neutron reflector and remain therein during normal operation of the nuclear reactor.

During the normal operation of the nuclear reactor, the stable isotope within the capsule housing will be exposed to neutrons, which will eventually irradiate the stable isotope and create a radioisotope. When the reactor undergoes refueling, the specimen capsule may be removed, and the irradiated nuclear isotope may be unloaded for processing. New stable material may then be inserted into the specimen capsule.

Since the specimen capsule housing may not be located within the reactor core, the specimen capsule will not cause a first-order disruption to the core flux or reactor power. In some circumstances, an isotope to be irradiated may have strong neutron-absorbing properties which may cause localized flux suppression near that capsule housing. Additionally, and/or alternatively, the isotope being irradiated may cause localized heating and may impact fuel rod performance or other local conditions if the isotope being irradiated emits strong decay particles. Such local conditions may cause excessive heat in the fuel rods and/or guide tube or may contribute to boiling of the coolant within the guide tubes. By locating the specimen capsule housings outside the core, these issues may be mitigated.

### ILLUSTRATIVE EMBODIMENTS

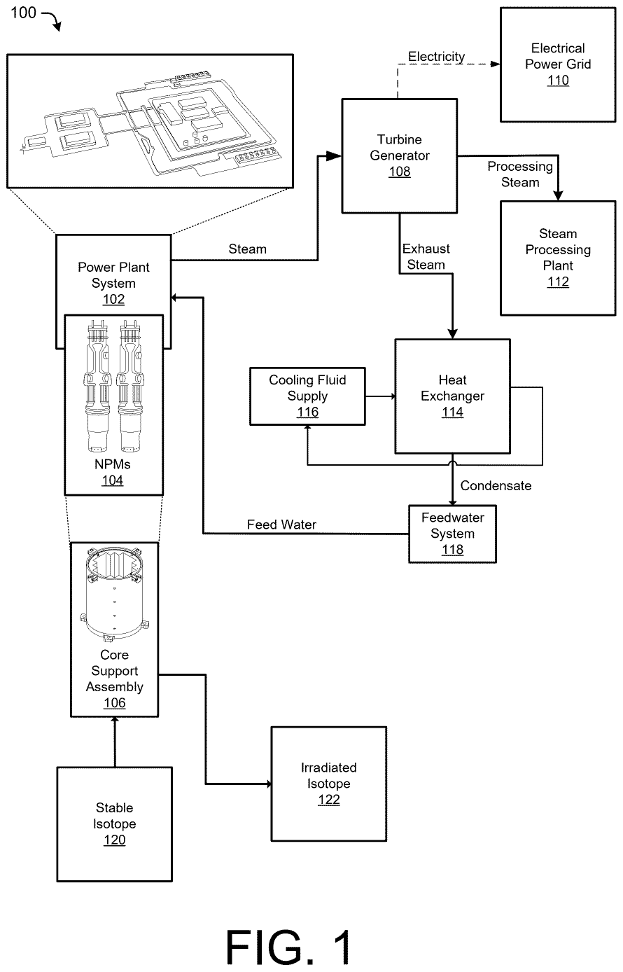

FIG. 1 schematically illustrates a Small Modular Reactor (SMR) power plant 100 that includes a power plant system 102 integrated with Nuclear Power Modules (NPMs) 104 that includes an embodiment of a core support assembly 106.

In an embodiment, the power plant system 102 may produce steam and direct the steam directly to the steam processing plant 112. In an embodiment, the power plant system 102 may produce steam and direct the steam to the turbine generator 108. The turbine generator 108 may utilize the steam to produce electricity that may be supplied to an electrical power grid 110. After utilizing the steam to produce electricity, the turbine generator 108 may direct processing steam to a steam processing plant 112 for additional processing (e.g., chemical production, etc.). After utilizing the steam to produce electricity, the turbine generator 108 may direct exhaust steam to a heat exchanger 114 (e.g., condenser, etc.). The heat exchanger 114 may receive fluid from a cooling fluid supply 116 (e.g., cooling water supply system, etc.) to remove heat from the exhaust steam. In an embodiment, after removing heat from the exhaust steam in the heat exchanger 114, the cooling fluid may be directed back to the cooling fluid supply 116. In an embodiment, the exhaust steam may transfer sufficient heat to the cooing fluid within the heat exchanger 114 to condense into a liquid condensate. The liquid condensate may be directed to a feedwater system 118. In an embodiment, the liquid condensate may be treated (e.g., chemical injection, etc.) and converted to feedwater. In an embodiment, the feedwater system may be directed to the power plant system 102.

In an embodiment, when an NPM 104 is shutdown, the core support assembly 106 for the shutdown NPM 104 may be loaded with a first amount of a stable isotope 120 (e.g., Co-59, etc.). During normal operation of the NPM 104, the first amount of the stable isotope 120 may be exposed to neutrons and become a first amount of an irradiated isotope 122 (e.g., Co-60). After the NPM 104 is once again shutdown, the first amount of the irradiated isotope 122 may be collected, and the core support assembly 106 may be loaded with a second amount of the stable isotope 120 in order to produce a second amount of the irradiated isotope 122.

In an embodiment, the production of the irradiated isotope 122 may take place simultaneously with the production of steam for the turbine generator 108.

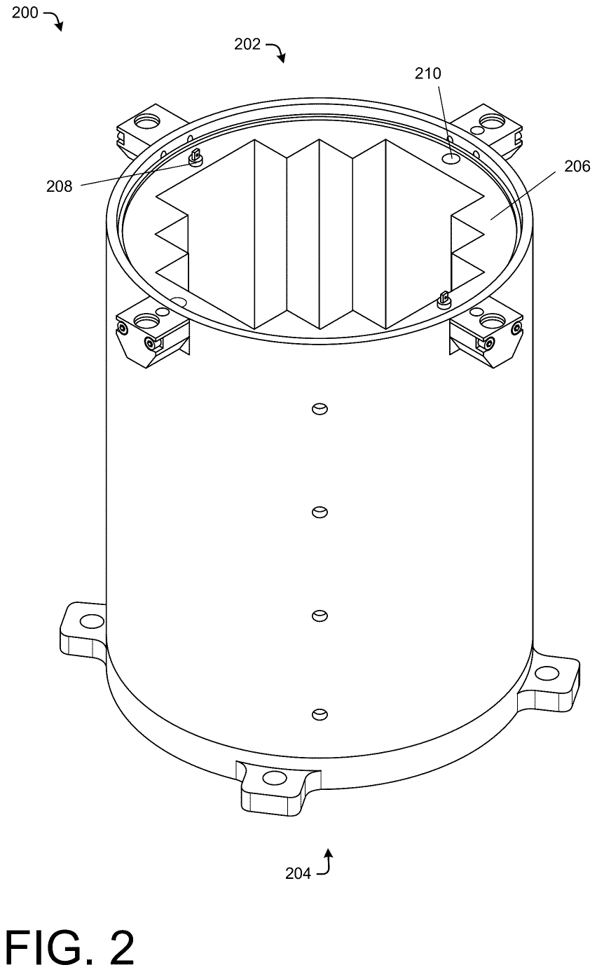

FIG. 2 illustrates an isometric view of a core support assembly 200 having a top end 202 and a bottom end 204. In an embodiment, the core support assembly may include a neutron reflector 206, a specimen capsule (not shown in FIG. 2), and a specimen capsule cover 208. In an embodiment, the neutron reflector may include a capsule well 210 (e.g., first capsule well, capsule channel, first channel, etc.) that extends from the top end 202 of the neutron reflector 206 toward the bottom end 204 of the neutron reflector 206. In an embodiment, the core support assembly may include multiple reflectors (e.g., multiple reflectors stacked vertically, etc.).

In an embodiment, the capsule well 210 may be configured to have a depth (e.g., first depth, etc.) within the neutron reflector 206. In an embodiment, the capsule well 210 may be sized such that the specimen capsule is fully disposed within the capsule well 210. In an embodiment, the specimen capsule cover 208 may be sized to at least partially extend above a top surface of the neutron reflector 206.

In an embodiment, specimen capsule cover 208 may have a width that is greater than the opening of the capsule well, such that when the specimen capsule is coupled with the specimen capsule cover 208 and inserted into the capsule well 210, the portion of the specimen capsule cover 208 may engage with a top surface of the neutron reflector 206. Accordingly, the specimen capsule may be suspended within the capsule well 210.

In an embodiment, the specimen capsule may have a length that is greater than the depth of the capsule well 210 such that, when disposed within the capsule well 210, at least a portion of the specimen capsule cover 208 extends above the top surface of the neutron reflector. In an embodiment, the specimen capsule may extend below the bottom of the neutron reflector.

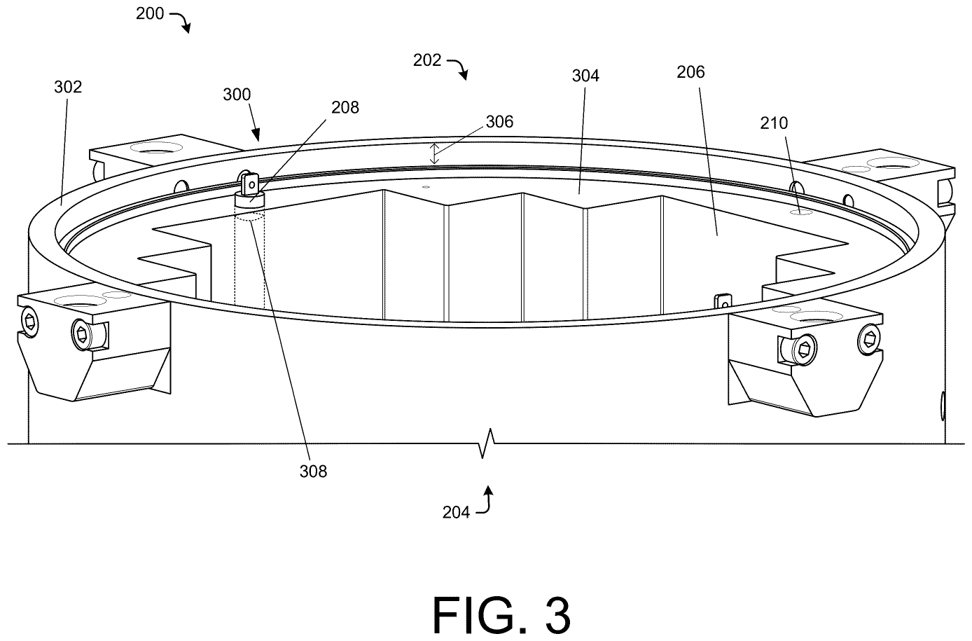

FIG. 3 illustrates a close-up isometric view of the top end 202 of a core support assembly 200. In an embodiment, the core support assembly 200 may include a core barrel 300 having a top surface 302. In an embodiment, the neutron reflector 206 may be disposed within the core barrel 300. The neutron reflector 206 may include a top surface 304. In an embodiment, the neutron reflector 206 may be disposed within the core barrel 300 such that the neutron reflector 206 is recessed within the core barrel 300. In an embodiment, the top surface 302 of the core barrel 300 may be separated from the top surface 304 of the neutron reflector 206 by a distance 306.

In an embodiment, the specimen capsule cover 208 may extend above the top surface 304 of the neutron reflector 206 by a distance that is less than the distance 306. For example, the top of the specimen capsule cover 208 may extend toward the top end 202 of the core barrel 300 but not extend above the top surface 302 of the core barrel 300.

In an embodiment, the capsule well 210 may include a circumferential groove 308 disposed within an interior surface of the capsule well 210. In an embodiment, the circumferential groove 308 may be positioned near the top of the capsule well 210, near the middle of the capsule well 210, or near the bottom of the capsule well 210, as desired. The circumferential groove 308 may be configured to receive a retaining clip or other securing mechanism to retain the specimen capsule and/or the specimen capsule cover 208 within the capsule well 210.

In an embodiment, the specimen capsule cover 208 may be configured such that the upper section 702 extends into a specimen capsule extraction hole in the upper core plate when the upper core plate is installed above the core support assembly 200. In such a configuration, the upper section 702 of the specimen capsule cover 208 may be sized to fit within the extraction hole while still allowing clearance for insertion and removal of the specimen capsule. The extraction hole may provide a guide path for the specimen capsule cover 208 during installation and extraction operations, facilitating alignment of the specimen capsule with the capsule well 210.

In an embodiment, the lower section 700 of the specimen capsule cover 208 may extend below the top surface 304 of the neutron reflector 206 and into the capsule well 210. In such an embodiment, the retaining clip 704 may engage with the circumferential groove 308 to secure the lower section 700 of the specimen capsule cover 208 within the capsule well 210. The upper section 702 of the specimen capsule cover 208 may protrude above the top surface 304 of the neutron reflector 206 to allow engagement with a lifting device for insertion and extraction of the specimen capsule.

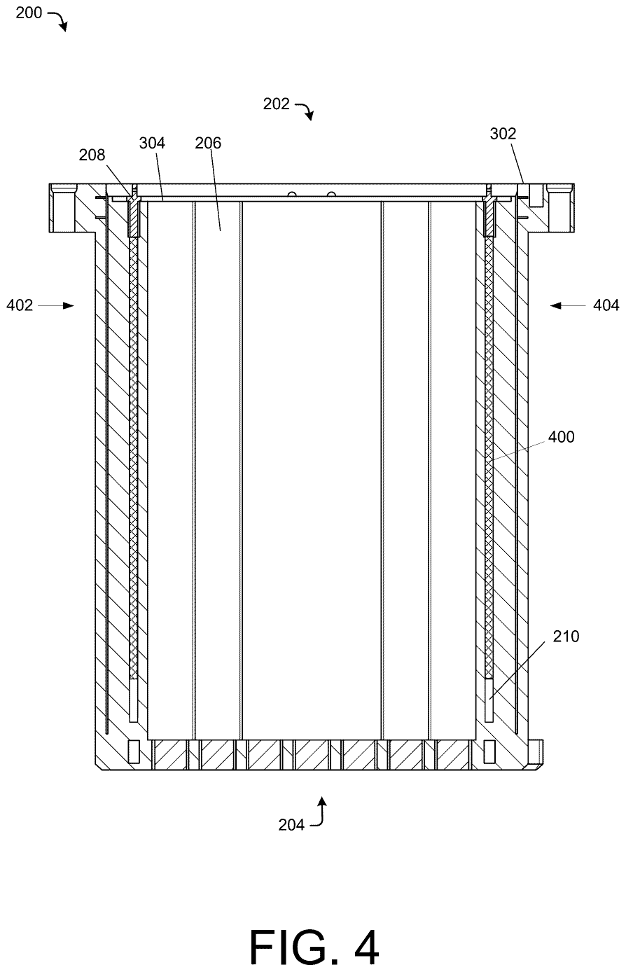

FIG. 4 illustrates a cross-sectional view of a core support assembly 200 with a specimen capsule 400 installed. In an embodiment, the core support assembly 200 may have a first side 402 (e.g., left side, front side, etc.) and a second side 404 (e.g., right side, rear side, etc.).

In an embodiment, the capsule well 210 may include a void (e.g., gap, space, etc.) at the bottom end 204 of the capsule well 210 when the specimen capsule 402 is installed.

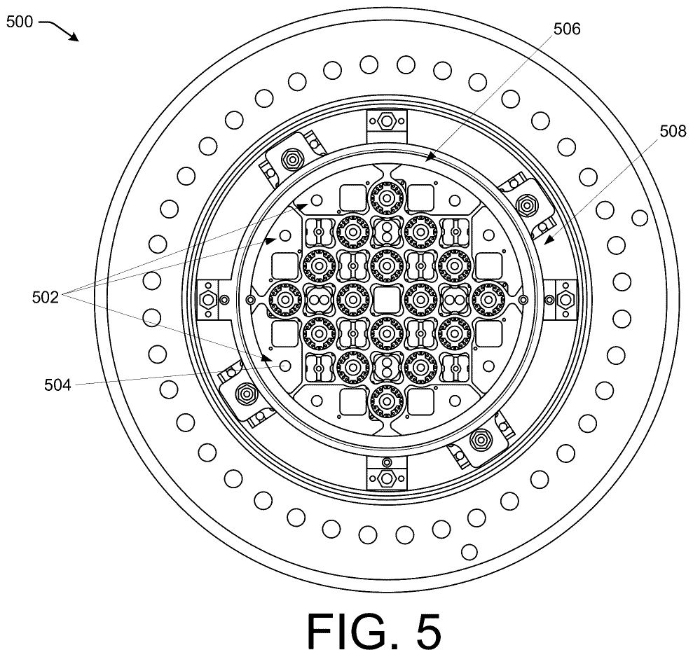

FIG. 5 illustrates a top-down view of a lower reactor pressure vessel 500 with a plurality 502 of specimen capsule extraction holes 504 extending through the upper core plate 506.

In an embodiment, the plurality 502 of specimen capsule extraction holes 504 may be radially disposed near an outside edge 508 of the upper core plate 506. Each specimen capsule extraction hole 504 may be sized and shaped to accommodate the specimen capsule cover 208 for each specimen capsule 400 installed within the neutron reflector 206. In an embodiment, a specimen capsule 400 may be removed from the neutron reflector 206 (e.g., lifted out via a crane, etc.) without removing the upper core plate 506.

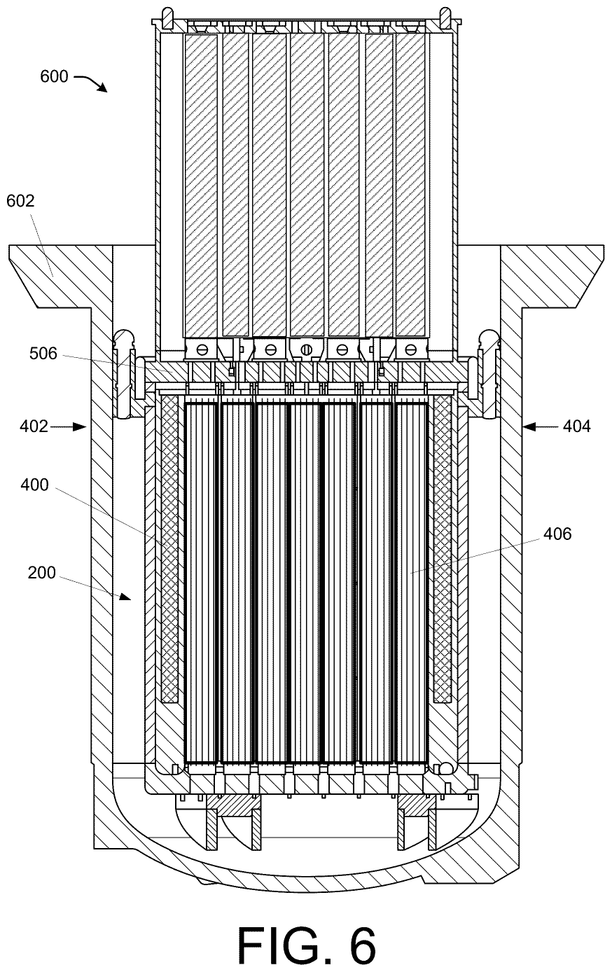

FIG. 6 illustrates a cross-sectional view of a partially disassembled portion of the lower reactor pressure vessel 500. In an embodiment, the portion of the lower reactor pressure vessel 500 may include a lower riser assembly 600, a core support assembly 200, and a lower reactor pressure vessel weldment 602.

In an embodiment, the lower riser assembly 600 may be engaged to (e.g., coupled with, etc.) the upper core plate 506. In an embodiment, the lower riser assembly 600, coupled with the upper core plate 506, may be partially disposed within the lower reactor pressure vessel weldment 602. In an embodiment, the core support assembly 200 may be fully disposed within the lower reactor pressure vessel weldment 602 when installed.

In an embodiment, the lower riser assembly 600 may be removed (e.g., lifted via a crane) from the lower reactor pressure vessel weldment 602 to expose the core support assembly 200. The lower riser assembly 600 may be removed to provide access to the fuel assemblies 406 during refueling. In the refueling configuration, the specimen capsule cover 208 for each specimen capsule 400 installed within the neutron reflector 206 is accessible. In an embodiment, each specimen capsule 400 may be removed from the neutron reflector 206 of the core support assembly 200 (e.g., via a crane, or other lifting device, etc.).

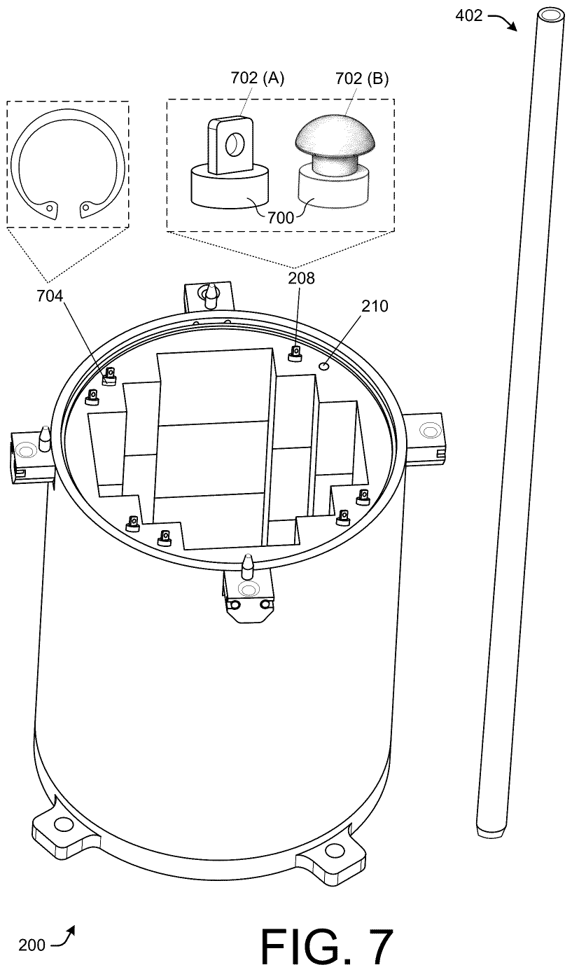

FIG. 7 illustrates an isometric view of a core support assembly 200, a specimen capsule 400, and a specimen capsule cover 208.

In an embodiment, the core support assembly 200 may include any number of capsule wells 210 as desired (e.g., 1, 2, 3, . . . n). Similarly, the core support assembly 200 may include any number of specimen capsules 400 as desired. In an embodiment, the core support assembly may include more capsule wells 210 than installed specimen capsules 400.

In an embodiment, the specimen capsule cover may include a lower section 700 (e.g., bottom section, sealing section, etc.), an upper section 702 (e.g., top section, latching section, etc.), and a retaining ring (or clip) 704. In an embodiment, the lower section 700 of the specimen capsule cover 208 may be configured to couple with the top end of the specimen capsule 400 via compression fit, welding, threading, or any other suitable means of engagement.

In an embodiment, the upper section 702 of the specimen capsule cover 208 may be configured to couple with a lifting device. For example, the upper section 702 may include an integral lifting lug, shackle, or other useful rigging feature.

In an embodiment, the specimen capsule 400 may be configured to be inserted and extracted from a side of the core support assembly 200. For example, the capsule well 210 may extend through the core support assembly at an angle relative to the core support assembly 200. In an embodiment, the upper section 702 may include a rectangular lifting lug configuration such as upper section 702 (A), which provides a lifting lug design suitable for engagement with a crane hook or other lifting device. In an embodiment, the upper section 702 may include a mushroom cap feature such as upper section 702 (B), which provides a dome-shaped or mushroom-shaped lifting configuration that may facilitate engagement with a grapple-type lifting device or provide a smooth profile for insertion and extraction through the specimen capsule extraction hole 504.

In an embodiment, the retaining ring 704 may be configured to engage in the circumferential groove 308. In an embodiment, the retaining ring 704 may be installed in the circumferential groove 308 as an additional and/or alternative method to secure the specimen capsule 400 and/or the specimen capsule cover 208. In an embodiment, the circumferential groove 308 may be an internal groove or channel disposed within the capsule well 210 at any spot, as desired (e.g., near the top, near the middle, near the bottom, etc.). In an embodiment, the capsule well 210 may include a plurality of retaining rings 704.

In an embodiment, a circumferential groove similar to the circumferential groove 308 may be disposed within an interior surface of the specimen capsule extraction hole 504. In such a configuration, the retaining ring 704 may be installed within the specimen capsule extraction hole 504 above the lower section 700 of the specimen capsule cover 208. This configuration may facilitate access to the retaining ring 704 with a tool during underwater operations, as an operator may reach the retaining ring 704 from above the upper core plate 506 rather than needing to feed a tool through the extraction hole to access a retaining ring below the upper core plate 506. In this configuration, the specimen capsule 400 may have a length such that the upper section 702 of the specimen capsule cover 208 protrudes above a top surface of the upper core plate 506.

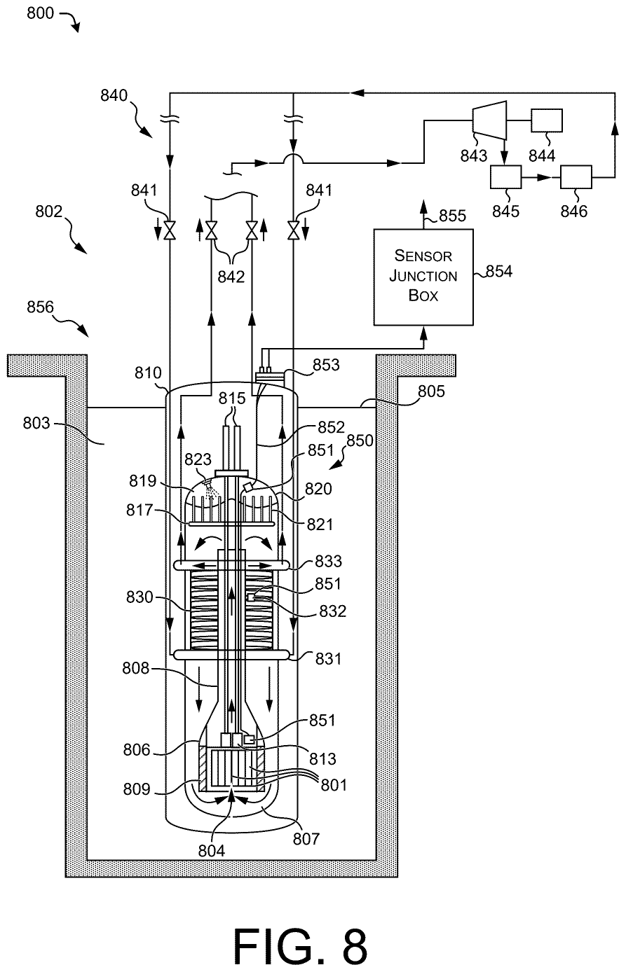

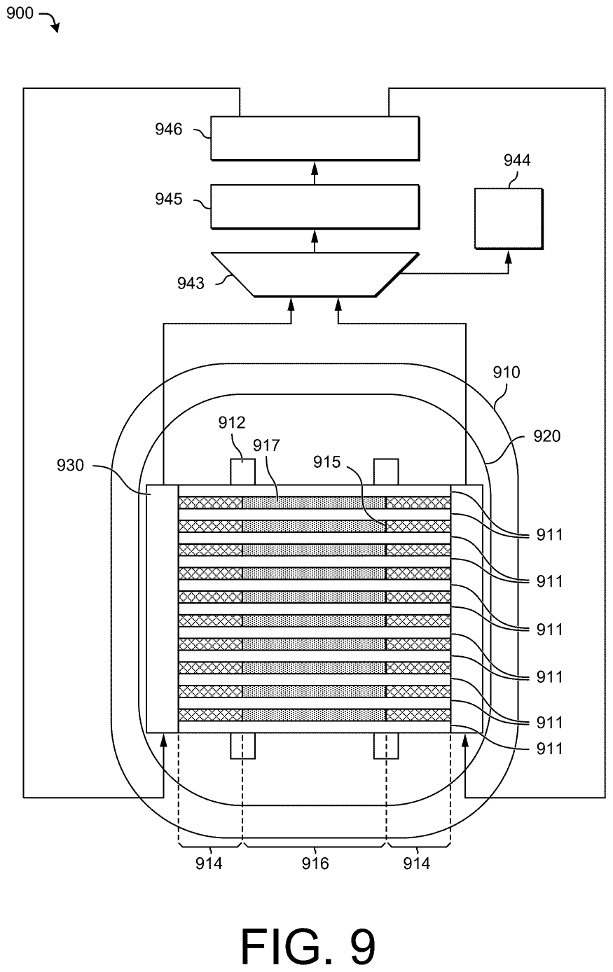

FIGS. 8 and 9 illustrate representative nuclear reactors that may be included in embodiments of the present technology. FIG. 8 is a partially schematic, partially cross-sectional view of a nuclear reactor system 800 configured in accordance with embodiments of the present technology. The system 800 can include a power module 802 having a reactor core 804 in which a controlled nuclear reaction takes place. Accordingly, the reactor core 804 can include one or more fuel assemblies 801. The fuel assemblies 801 can include fissile and/or other suitable materials. Heat from the reaction generates steam at a steam generator 830, which directs the steam to a power conversion system 840. The power conversion system 840 generates electrical power, and/or provides other useful outputs, such as super-heated steam. A sensor system 850 is used to monitor the operation of the power module 802 and/or other system components. The data obtained from the sensor system 850 can be used in real time to control the power module 802, and/or can be used to update the design of the power module 802 and/or other system components.

The power module 802 includes a containment vessel 810 (e.g., a radiation shield vessel, or a radiation shield container) that houses/encloses a reactor vessel 820 (e.g., a reactor pressure vessel, or a reactor pressure container), which in turn houses the reactor core 804. The containment vessel 810 can be housed in a power module bay 856. The power module bay 856 can contain a cooling pool 803 filled with water and/or another suitable cooling liquid. The bulk of the power module 802 can be positioned below a surface 805 of the cooling pool 803. Accordingly, the cooling pool 803 can operate as a thermal sink, for example, in the event of a system malfunction.

A volume between the reactor vessel 820 and the containment vessel 810 can be partially or completely evacuated to reduce heat transfer from the reactor vessel 820 to the surrounding environment (e.g., to the cooling pool 803). However, in other embodiments the volume between the reactor vessel 820 and the containment vessel 810 can be at least partially filled with a gas and/or a liquid that increases heat transfer between the reactor vessel 820 and the containment vessel 810. For example, the volume between the reactor vessel 820 and the containment vessel 810 can be at least partially filled (e.g., flooded with the primary coolant 807) during an emergency operation.

Within the reactor vessel 820, a primary coolant 807 conveys heat from the reactor core 804 to the steam generator 830. For example, as illustrated by arrows located within the reactor vessel 820, the primary coolant 807 is heated at the reactor core 804 toward the bottom of the reactor vessel 820. The heated primary coolant 807 (e.g., water with or without additives) rises from the reactor core 804 through a core shroud 806 and to a riser tube 808. The hot, buoyant primary coolant 807 continues to rise through the riser tube 808, then exits the riser tube 808 and passes downwardly through the steam generator 830. The steam generator 830 includes a multitude of conduits 832 that are arranged circumferentially around the riser tube 808, for example, in a helical pattern, as is shown schematically in FIG. 8. The descending primary coolant 807 transfers heat to a secondary coolant (e.g., water) within the conduits 832, and descends to the bottom of the reactor vessel 820 where the cycle begins again. The cycle can be driven by the changes in the buoyancy of the primary coolant 807, thus reducing or eliminating the need for pumps to move the primary coolant 807.

The steam generator 830 can include a feedwater header 831 at which the incoming secondary coolant enters the steam generator conduits 832. The secondary coolant rises through the conduits 832, converts to vapor (e.g., steam), and is collected at a steam header 833. The steam exits the steam header 833 and is directed to the power conversion system 840.

The power conversion system 840 can include one or more steam valves 842 that regulate the passage of high pressure, high temperature steam from the steam generator 830 to a steam turbine 843. The steam turbine 843 converts the thermal energy of the steam to electricity via a generator 844. The low-pressure steam exiting the turbine 843 is condensed at a condenser 845, and then directed (e.g., via a pump 846) to one or more feedwater valves 841. The feedwater valves 841 control the rate at which the feedwater re-enters the steam generator 830 via the feedwater header 831. In other embodiments, the steam from the steam generator 830 can be routed for direct use in an industrial process, such as a Hydrogen (H₂) and Oxygen (O₂) production plant, a chemical production plant, and/or the like, as described in detail below. Accordingly, steam exiting the steam generator 830 can bypass the power conversion system 840.

The power module 802 includes multiple control systems and associated sensors. For example, the power module 802 can include a hollow cylindrical reflector 809 that directs neutrons back into the reactor core 804 to further the nuclear reaction taking place therein. Control rods 813 are used to modulate the nuclear reaction and are driven via control rod drivers 815. A pressurizer plate 817 (e.g., pressurizer baffle plate) separates the two-phase fluid inside a pressurizing volume 819 from the subcooled fluid below the pressurizer plate 817. The pressurizer plate 817 can also serve to direct the primary coolant 807 downwardly through the steam generator 830. The pressure within the reactor vessel 820 can be controlled via pressurizer heaters 821 and pressurizer spray 823 positioned within the pressurizing volume 819. For example, the pressurizer heaters 821 may increase pressure by heating the fluid within the pressurizing volume 819, and the pressurizer spray 823 may decrease pressure by introducing cooler fluid into the pressurizing volume 819.

The sensor system 850 can include one or more sensors 851 positioned at a variety of locations within the power module 802 and/or elsewhere, for example, to identify operating parameter values and/or changes in parameter values. The data collected by the sensor system 850 can then be used to control the operation of the system 800, and/or to generate design changes for the system 800. For sensors positioned within the containment vessel 810, a sensor link 852 directs data from the sensors to a flange 853 (at which the sensor link 852 exits the containment vessel 810) and directs data to a sensor junction box 854. From there, the sensor data can be routed to one or more controllers and/or other data systems via a data bus 855.

FIG. 9 is a partially schematic, partially cross-sectional view of a nuclear reactor system 900 configured in accordance with additional embodiments of the present technology. In some embodiments, the nuclear reactor system 900 (“system 900”) can include some features that are at least generally similar in structure and function, or identical in structure and function, to the corresponding features of the system 800 described in detail above with reference to FIG. 8, and can operate in a generally similar or identical manner to the system 800.

In the illustrated embodiment, the system 900 includes a reactor vessel 920 and a containment vessel 910 surrounding/enclosing the reactor vessel 920. In some embodiments, the reactor vessel 920 and the containment vessel 910 can be roughly cylinder-shaped or capsule-shaped. The system 900 further includes a plurality of heat pipe layers 911 within the reactor vessel 920. In the illustrated embodiment, the heat pipe layers 911 are spaced apart from and stacked over one another. In some embodiments, the heat pipe layers 911 can be mounted/secured to a common frame 912, a portion of the reactor vessel 920 (e.g., a wall thereof), and/or other suitable structures within the reactor vessel 920. In other embodiments, the heat pipe layers 911 can be directly stacked on top of one another such that each of the heat pipe layers 911 supports and/or is supported by one or more of the other ones of the heat pipe layers 911.

In the illustrated embodiment, the system 900 further includes a shield or reflector region 914 at least partially surrounding a core region 916. The heat pipe layers 911 can be circular, rectilinear, polygonal, and/or can have other shapes, such that the core region 916 has a corresponding three-dimensional shape (e.g., cylindrical, spherical). In some embodiments, the core region 916 is separated from the reflector region 914 by a core barrier 915, such as a metal wall. The core region 916 can include one or more fuel sources, such as fissile material, for heating the heat pipe layers 911. The reflector region 914 can include one or more materials configured to contain/reflect products generated by burning the fuel in the core region 916 during operation of the system 900. For example, the reflector region 914 can include a liquid or solid material configured to reflect neutrons and/or other fission products radially inward toward the core region 916. In some embodiments, the reflector region 914 can entirely surround the core region 916. In other embodiments, the reflector region 914 may partially surround the core region 916. In some embodiments, the core region 916 can include a control material 917, such as a moderator and/or coolant. The control material 917 can at least partially surround the heat pipe layers 911 in the core region 916 and can transfer heat therebetween.

In the illustrated embodiment, the system 900 further includes at least one heat exchanger 930 (e.g., a steam generator) positioned around the heat pipe layers 911. The heat pipe layers 911 can extend from the core region 916 and at least partially into the reflector region 914 and are thermally coupled to the heat exchanger 930. In some embodiments, the heat exchanger 930 can be positioned outside of or partially within the reflector region 914. The heat pipe layers 911 provide a heat transfer path from the core region 916 to the heat exchanger 930. For example, the heat pipe layers 911 can each include an array of heat pipes that provide a heat transfer path from the core region 916 to the heat exchanger 930. When the system 900 operates, the fuel in the core region 916 can heat and vaporize a fluid within the heat pipes in the heat pipe layers 911, and the fluid can carry the heat to the heat exchanger 930. The heat pipes in the heat pipe layers 911 can then return the fluid toward the core region 916 via wicking, gravity, and/or other means to be heated and vaporized once again.

In some embodiments, the heat exchanger 930 can be similar to the steam generator 830 of FIG. 8 and, for example, can include one or more helically-coiled tubes that wrap around the heat pipe layers 911. The tubes of the heat exchanger 930 can include or carry a working fluid (e.g., a coolant such as water or another fluid) that carries the heat from the heat pipe layers 911 out of the reactor vessel 920 and the containment vessel 910 for use in generating electricity, steam, and/or the like. For example, in the illustrated embodiment the heat exchanger 930 is operably coupled to a turbine 943, a generator 944, a condenser 945, and a pump 946. As the working fluid within the heat exchanger 930 increases in temperature, the working fluid may begin to boil and vaporize. The vaporized working fluid (e.g., steam) may be used to drive the turbine 943 to convert the thermal potential energy of the working fluid into electrical energy via the generator 944. The condenser 945 can condense the working fluid after it passes through the turbine 943, and the pump 946 can direct the working fluid back to the heat exchanger 930 where it can begin another thermal cycle. In other embodiments, steam from the heat exchanger 930 can be routed for direct use in an industrial process, such as an enhanced oil recovery operation described in detail below. Accordingly, steam exiting the heat exchanger 930 can bypass the turbine 943, the generator 944, the condenser 945, the pump 946, etc.

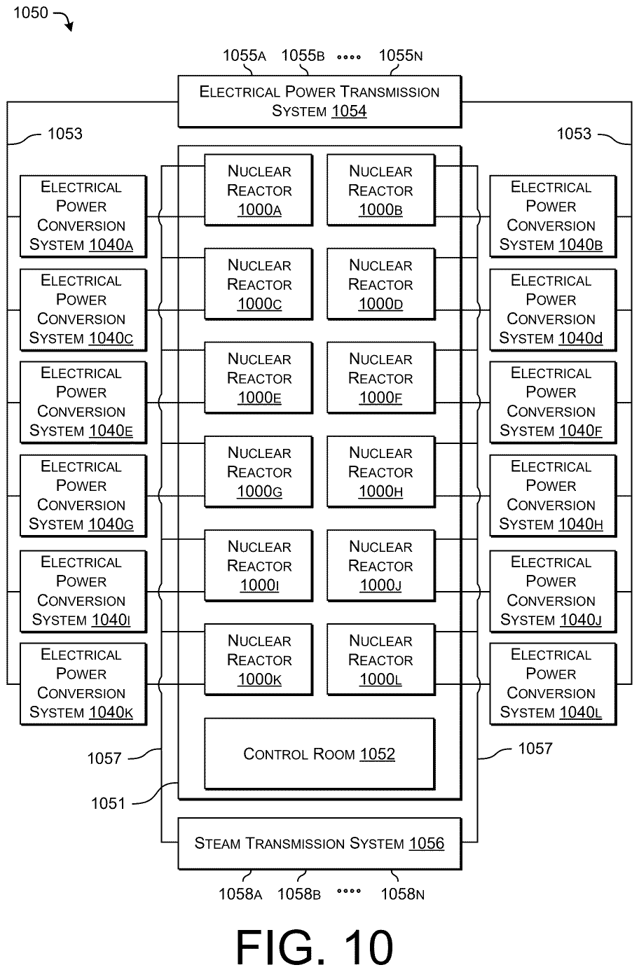

FIG. 10 is a schematic view of a nuclear power plant system 1050 including multiple nuclear reactors 1000 in accordance with embodiments of the present technology. Each of the nuclear reactors 1000 (individually identified as first through twelfth nuclear reactors 1000a-l, respectively) can be similar to or identical to the nuclear reactor 1000 and/or the nuclear reactor 1000 described in detail above with reference to FIGS. 8 and 9. The power plant system 1050 (“power plant system 1050”) can be “modular” in that each of the nuclear reactors 1000 can be operated separately to provide an output, such as electricity or steam. The power plant system 1050 can include fewer than twelve of the nuclear reactors 1000 (e.g., two, three, four, five, six, seven, eight, nine, ten, or eleven of the nuclear reactors 1000), or more than twelve of the nuclear reactors 1000. The power plant system 1050 can be a permanent installation or can be mobile (e.g., mounted on a truck, tractor, mobile platform, and/or the like). In the illustrated embodiment, each of the nuclear reactors 1000 can be positioned within a common housing 1051, such as a reactor plant building, and controlled and/or monitored via a control room 1052.

Each of the nuclear reactors 1000 can be coupled to a corresponding electrical power conversion system 1040 (individually identified as first through twelfth electrical power conversion systems 1040a-l, respectively). The electrical power conversion systems 1040 can include one or more devices that generate electrical power or some other form of usable power from steam generated by the nuclear reactors 1000. In some embodiments, multiple ones of the nuclear reactors 1000 can be coupled to the same one of the electrical power conversion systems 1040 and/or one or more of the nuclear reactors 1000 can be coupled to multiple ones of the electrical power conversion systems 1040 such that there is not a one-to-one correspondence between the nuclear reactors 1000 and the electrical power conversion systems 1040.

The electrical power conversion systems 1040 can be further coupled to an electrical power transmission system 1054 via, for example, an electrical power bus 1053. The electrical power transmission system 1054 and/or the electrical power bus 1053 can include one or more transmission lines, transformers, and/or the like for regulating the current, voltage, and/or other characteristic(s) of the electricity generated by the electrical power conversion systems 1040. The electrical power transmission system 1054 can route electricity via a plurality of electrical output paths 1055 (individually identified as electrical output paths 1055a-n) to one or more end users and/or end uses, such as different electrical loads of an integrated energy system.

Each of the nuclear reactors 1000 can further be coupled to a steam transmission system 1056 via, for example, a steam bus 1057. The steam bus 1057 can route steam generated from the nuclear reactors 1000 to the steam transmission system 1056 which in turn can route the steam via a plurality of steam output paths 1058 (individually identified as steam output paths 1058a-n) to one or more end users and/or end uses, such as different steam inputs of an integrated energy system.

In some embodiments, the nuclear reactors 1000 can be individually controlled (e.g., via the control room 1052) to provide steam to the steam transmission system 1056 and/or steam to the corresponding one of the electrical power conversion systems 1040 to provide electricity to the electrical power transmission system 1054. In some embodiments, the nuclear reactors 1000 are configured to provide steam either to the steam bus 1057 or to the corresponding one of the electrical power conversion systems 1040 and can be rapidly and efficiently switched between providing steam to either. Accordingly, in some aspects of the present technology the nuclear reactors 1000 can be modularly and flexibly controlled such that the power plant system 1050 can provide differing levels/amounts of electricity via the electrical power transmission system 1054 and/or steam via the steam transmission system 1056. For example, where the power plant system 1050 is used to provide electricity and steam to one or more industrial process-such as various components of the integrated energy systems, the nuclear reactors 1000 can be controlled to meet the differing electricity and steam requirements of the industrial processes.

As one example, during a first operational state of an integrated energy system employing the power plant system 1050, a first subset of the nuclear reactors 1000 (e.g., the first through sixth nuclear reactors 1000a-f) can be configured to provide steam to the steam transmission system 1056 for use in the first operational state of the integrated energy system, while a second subset of the nuclear reactors 1000 (e.g., the seventh through twelfth nuclear reactors 1000g-l) can be configured to provide steam to the corresponding ones of the electrical power conversion systems 1040 (e.g., the seventh through twelfth electrical power conversion systems 1040g-l) to generate electricity for the first operational state of the integrated energy system. Then, during a second operational state of the integrated energy system when a different (e.g., greater or lesser) amount of steam and/or electricity is required, some or all the first subset of the nuclear reactors 1000 can be switched to provide steam to the corresponding ones of the electrical power conversion systems 1040 (e.g., the seventh through twelfth electrical power conversion systems 1040g-l) and/or some or all of the second subset of the nuclear reactors 1000 can be switched to provide steam to the steam transmission system 1056 to vary the amount of steam and electricity produced to match the requirements/demands of the second operational state. Other variations of steam and electricity generation are possible based on the needs of the integrated energy system. That is, the nuclear reactors 1000 can be dynamically/flexibly controlled during other operational states of an integrated energy system to meet the steam and electricity requirements of the operational state.

In contrast, some conventional nuclear power plant systems can typically generate either steam or electricity for output and cannot be modularly controlled to provide varying levels of steam and electricity for output. Moreover, it is typically difficult (e.g., expensive, time consuming, etc.) to switch between steam generation and electricity generation in conventional nuclear power plant systems. Specifically, for example, it is typically extremely time-consuming to switch between steam generation and electricity generation in prototypical large nuclear power plant systems.

The nuclear reactors 1000 can be individually controlled via one or more operators and/or via a computer system. Accordingly, many embodiments of the technology described herein may take the form of computer-or machine-or controller-executable instructions, including routines executed by a programmable computer or controller. Those skilled in the relevant art will appreciate that the technology can be practiced on computer/controller systems other than those shown and described herein. The technology can be embodied in a special-purpose computer, controller or data processor that is specifically programmed, configured, or constructed to perform one or more of the computer-executable instructions described below. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like). Information handled by these computers can be presented at any suitable display medium, including a liquid crystal display (LCD).

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the embodiments of the technology.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

As used herein, terms such as “attached,” “fastened,” “secured,” “disposed,” “connected,” and “coupled” (including variations thereof) are intended to be used interchangeably to refer to any form of interaction between components, whether directly or indirectly, permanently or temporarily, mechanically or otherwise. It will be understood that these terms are not intended to limit the nature of the interaction to a direct or immediate connection unless specifically stated and may include indirect connections through one or more intermediary elements. Likewise, the terms “directly” and “indirectly” describe both physical contact between components and connections made through intermediate structures, mechanisms, or devices.

What is claimed is:

1. A system comprising:
a nuclear power plant, including:
a reactor core, and
a reactor core support assembly adjacent to the reactor core, the reactor core support assembly including:
a neutron reflector,
a specimen capsule well extending from a top end of the neutron reflector toward the bottom end of the neutron reflector,
an isotope specimen capsule configured to be disposed within the specimen capsule well, and
an isotope specimen disposed within the isotope specimen capsule.

2. The system according to claim 1, wherein the isotope specimen capsule includes a specimen capsule housing and a specimen capsule cover.

3. The system according to claim 2, wherein the specimen capsule cover is welded to the specimen capsule housing.

4. The system according to claim 2, wherein the specimen capsule cover includes an integral lifting feature.

5. The system according to claim 1, wherein the isotope specimen is Cobalt-59.

6. The system, according to claim 1, the lower reactor coolant system subassembly further including an upper core plate coupled to a bottom end of the lower riser assembly.

7. The system according to claim 6, wherein the upper core plate includes a plurality of extraction holes to allow access to the isotope specimen capsule.

8. A method, comprising:
loading an isotope specimen into an isotope specimen capsule having a specimen capsule housing and a specimen capsule cover;
coupling the specimen capsule to a lifting device via the specimen capsule cover;
inserting, via the lifting device, the specimen capsule into a neutron reflector of a nuclear reactor;
generating an irradiated isotope specimen via operation of the nuclear reactor;
removing the specimen capsule, via a lifting device, from the neutron reflector; and
removing the irradiated isotope specimen from the isotope specimen capsule.

9. The method according to claim 8, further comprising sealing the specimen capsule cover to a top end of the specimen capsule housing.

10. The method according to claim 9, wherein sealing the specimen capsule cover to the top end of the specimen capsule housing includes welding the specimen capsule to the specimen capsule housing.

11. The method of claim 8, wherein:
the isotope specimen is Cobalt-59, and
the irradiated isotope specimen is Cobalt-60.

12. The method of claim 8, wherein the specimen capsule cover includes an integral lifting feature.

13. The method of claim 8, wherein the neutron reflector is disposed within a core support assembly.

14. The method of claim 13, wherein the lower riser assembly includes an upper core plate coupled to a top end of the reactor core support assembly, the upper core plate including a plurality of extraction holes to allow access to the isotope specimen capsule.

15. A reactor core support assembly including:
a neutron reflector,
a specimen capsule well extending from a top end of the neutron reflector toward the bottom end of the neutron reflector,
an isotope specimen capsule configured to be disposed within the specimen capsule well, and
an isotope specimen disposed within the isotope specimen capsule.

16. The reactor core support assembly according to claim 15, wherein the isotope specimen capsule includes a specimen capsule housing and a specimen capsule cover.

17. The reactor core support assembly according to claim 16, wherein the specimen capsule cover is welded to the specimen capsule housing.

18. The reactor core support assembly according to claim 16, wherein the specimen capsule cover includes an integral lifting feature.

19. The reactor core support assembly according to claim 15, wherein the isotope specimen is Cobalt-59.

20. The reactor core support assembly according to claim 15 further comprising an upper core plate coupled to a top end of the reactor core support assembly, the upper core plate including a plurality of extraction holes to allow access to the isotope specimen capsule.
